(19) United States
(12) Patent Application Publication
(10) Pub. No.: US 2015/0106751 A1
(43) Pub. Date: Apr. 16, 2015

(54) Systems And Methods For Creating And Serving Dynamically Adjustable Web Pages

(71) Applicant: ContentActivator, Dana Point, CA (US)

(72) Inventors: Jonathan Farjo, Dana Point, CA (US); Daniel Williams, Orange, CA (US); Todd Snyder, Laguna Niguel, CA (US)

(21) Appl. No.: 14/513,145

(22) Filed: Oct. 13, 2014

Related U.S. Application Data
(60) Provisional application No. 61/890,040, filed on Oct. 11, 2013.

(51) Int. Cl. G06F 17/30; G06F 17/22; G06F 3/0484

(52) U.S. Cl. CPC G06F 17/30893; G06F 3/0484; G06F 17/2247
USPC 715/760

(57) ABSTRACT

A system that generates content pages for various devices, browsers, and browser screen sizes is disclosed. A content page generator could use pre-defined templates to populate a content page with blocks of media, such as text, images, video clips, and audio clips. The system will then automatically determine breakpoints which define thresholds where the organization of the content page changes. Client code is generated for the device which will alter the organizational structure of how the blocks of media are presented to a client user depending upon device attributes, such as the dimensions of the screen or the orientation towards a user.

This application claims the benefit of priority to U.S. provisional application 61/890,040 filed on Oct. 11, 2013. This and all other extrinsic references referenced herein are incorporated by reference in their entirety.

### FIELD OF THE INVENTION

The field of the invention is dynamic web pages.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The field of website authoring has undergone many phases of development innovation. Beginning with a simple tool such as a text editor for creating html (e.g., “notepad”), website authors created website contents using little to no graphical tools. Currently, the tools available to create websites and other content pages are more advanced, in that they provide website authors and creators a wide variety of graphical user interfaces (“GUIs”) that have much more powerful tools reducing the time to generate websites while allowing for additional complexity. Examples of such tools include Macromedia Dreamweaver®, Microsoft® FrontPage®, QuickSite®, Visual Page®, and NetObjects Fusion®.

To allow websites or other content pages to be updated more quickly, it is also known to provide systems that allow users to build websites using ready-made components or templates. Examples of such systems are described in WIPO publ. no. 2007/001873 to The Zeppo Network, Inc. (publ. January 2007) and U.S. pat. publ. no. 2013/0198658 to Mokhtarzada, et al. (publ. August 2013). However, such systems, among other deficiencies, fail to allow for the generation of dynamically adaptable websites and other web pages which change depending upon the user's device characteristics. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

With the rapid growth of non-traditional computing devices, such as web-enabled tablets and smart phones, companies are finding that their previous websites require updating to ensure a pleasant user experience for those viewing their websites. Typically, such companies have paid a developer to prepare a separate mobile website or application designed specifically for non-traditional computing devices. US pat. publ. no. 2014/0095583 to Houle (publ. Apr. 3, 2014) teaches a system that allows a user to switch to different versions of a website based upon certain prerequisite conditions. Unfortunately, these mobile websites while possibly improving users' experiences, typically have significantly reduced functionality to ensure that the site can be viewed on any device. In addition, the mobile websites only add further to the complexity, time, and effort of website development.

While current web authoring systems provide more powerful tools to create websites having consistent look and feel throughout, these systems leave a great deal to be desired concerning a website's ability to adapt to the capabilities of the variety of possible devices to which the website contents would be served. This presents many challenges, such as unpredictability in user experience and performance. For example, while website contents might be suitable for serving on a traditional web browser running on a desktop computer, the same contents may not be usable when served on a non-traditional computing device, such as a mobile phone or a small tablet.

US pat. publ. no. 2014/0006936 to Shekey (publ. Jan 2, 2014) teaches a system that allows a user to create a plurality of versions of a website, which changes depending upon the width of the window the user is using to view the website. When the width of the window changes past a breakpoint threshold, the website view changes to a new configuration. Requiring an admin to a website to set individual breakpoint widths in terms of a number of pixels and set forth a plurality of website configurations is burdensome to a new website creator who is more interested in content creation than website configuration.

Thus, there is a need for systems and methods that allow for the creation of websites and other web pages that can be easily dynamically adapted for reviewing on a user's device.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems, and methods in which a system for generating a content page automatically derives breakpoints for a plurality of section objects on the content page.

The system uses templates to make it easier for a user to create a content page from scratch. Templates are generally stored in a template database that stores one or more section objects. Each section object has a set of media placeholders, which act as areas which hold media content, and which a user creating a content page could populate with various types of media objects.

Contemplated section objects include text blocks, media blocks, text and media blocks media grid blocks, media gallery blocks, content slider blocks, tab blocks, table blocks, list blocks, page list blocks, social feed blocks, social link blocks, social share blocks, form blocks, contact information blocks, and custom made blocks. Text blocks are sections of a content page that hold blocks of text, referred to as text media objects. Media blocks are sections of a content page that hold non-text media objects, such as images, audio clips, or video clips—referred to as image media objects, audio media objects, and video media objects, respectively. Text and media blocks are sections of a content page that hold both blocks of data and media objects, such as one or more blocks of text to a side of an image or just above or just below a video file. Media grid blocks are sections of a content page that hold non-text media objects and/or text media objects in a grid pattern. Media gallery blocks are sections of a content page that show media objects as a gallery of media to be showcased, usually displayed as one or more lines of thumbnails set forth above or below a larger window that shows a larger image or video, or a list of audio file titles along with a currently playing audio file. Content slider blocks are sections of a content page that show a small set of media objects, having a slider button that slides from one set of media objects to another set of media objects when the slider button is activated.

Tab blocks are sections of a content page that have a plurality of sets of media object content, where each set is associated with a tab, and which becomes visible on the screen when a set's respective tab has been activated. Table blocks are sections of a content page that store media objects within a table of columns and rows. List blocks are sections of a content page that store media objects in a structured list. Page list blocks are sections of a content page that store lists of links to other content pages along with media content associated with the content page, such as a link to a content page within a block that contains an image representing the link to the content page and a descriptive text representing the link to the content page. Social feed blocks are similar to list blocks, but are linked to an entity's social network(s) and automatically populate when a new social feed has been created by that entity. Social link blocks are similar to page list blocks, but are linked to an entity's social profiles. Social share blocks are sections of a content page that allow a visitor to the content page to share content from the content page via one or more social media platforms. Form blocks are sections of a content page that accept form information from a visitor to the content page. Contact information are sections of a content page that display information such as business location, phone number, email address, and other related contact details as a set of media objects. Custom made blocks are sections of a content page that are custom-made by users who wish to code their own blocks using native tools such as HTML, CSS, and/or JavaScript.

The system typically interacts with a page content creator through a page generation user interface, such as a computer monitor, touch screen, keyboard, and/or mouse. The page generation user interface could present a user with a list of template section objects, which the user could select to populate a content page. Once a section object has been selected, the user could define content for each section object (e.g. upload media objects and/or use tools to create media objects through the user interface), define attributes for each section object, and/or place the section object in designated areas of a content page. Preferably a plurality of section objects are created and are set forth on the content page in some sort of configuration by the user. (e.g. placing one section object above or below another section object, placing one section object to the left or to the right of another section object, or surrounding one section object with another section object)

Once the user has selected and defined one or more section objects for a content page, a page configuration engine could then automatically derive a set of breakpoints for the content page. Such breakpoints are typically derived as a function of one or more attributes of a section object. For example, where a section object contains a text media object, one of the dimensions of the text media object, such as the length or the width of a text box, could be used to determine the breakpoint. Alternatively, where a section object contains a non-text media object, the length or the width of the visual representation of the non-text media object could be used to determine the breakpoint. Where a set of media objects are set forth on a content page, a plurality of attributes from a subset of the media objects could be used to derive a breakpoint. The breakpoints could be derived from any attributes of the section object. For example a width breakpoint could be derived from a width of a section object, a height breakpoint could be derived from a height of a section object, or a pointer breakpoint could be derived from a location of a section object that a pointer on a client device might be located. The breakpoint functions which define how such breakpoints are derived from attributes of the section objects are typically contained within the templates. Some breakpoints could be defined by constants (e.g. a breakpoint set at 100 pixels from the left-most border of a media object) but are preferably defined by attributes of a section object (e.g. a breakpoint set 20 pixels to the left of 120% of the size of an image media object).

The derived breakpoints are used by client code to ensure that the content page is displayed in an appropriate configuration on a client device. Typically, the client code is generated by a page server that generates such client code based upon the settings generated by the user via the page generation user interface and the breakpoints derived by the page configuration engine. In some embodiments, the page server also uses attributes of the client device to generate the client code. Exemplary client devices could include, for example, desktop computers, laptops, tablet PCs, smart phones, smart watches, televisions, and any other computing device capable of presenting a content page to a user. When the page server transmits this client code to the client device, the client device then executes the client code, which determines the configuration of how section objects will be displayed on the content page on a user interface of the client device as a function of a set of derived breakpoints and a set of device attributes on a client device. For example, the client code might be configured to determine the dimensions of a web browser that displays the content page. If the width of the web browser is below a width breakpoint, the client code could display the section objects in one configuration, but if the width of the web browser is above the width breakpoint, the client code could display the section objects in another configuration. Any device attributes could be used and compared to the various breakpoints to alter the configuration of the content page. Contemplated device attributes include at least one of a screen size, a screen resolution, a device type, a browser, a browser version, a device operating system, and a device bandwidth.

The systems and methods described herein advantageously allow for the generation of a dynamically responsive pages, which can be adapted to a variety of different computing devices while maintaining a consistency of the look and feel of the individual pages across devices. For example, a page can be configured typically via the client code residing in the page such that the page alters an orientation or placement of the content of a page depending on the screen size of a user's device. Different content for the page could also be served to the user's device depending on one or more device attributes, such as those described above, and/or user preferences. For example, when viewing a page on a smart phone versus a desktop computer, the page server can automatically provide to the smart phone an image having a lower resolution than the resolution of that image served to the desktop computer. Thus, in this manner, the client code of the first page can be utilized to request and serve the appropriate set of content for a page depending on the set of device attributes in order to optimize performance.

In some embodiments, the method further comprises the steps of the page server receiving a page request from a second client device, and returning the first page that contains the client code. The method also includes the step where the client code analyzes a second set of device attributes of the second device, and generates a second content page based on the at least one of the section object of the first page, wherein the client code requests a set of media objects different that the set of media objects requested for the first device. The client code can present the second content page to a user as a function of the one or more breakpoints, such that the second content page is configured for presentation on the second device.

In some embodiments, the first client device is a laptop computer and the second client device is a smart phone, wherein the first and second content pages are generated from the first page and the client code. However, the media objects on the first content page may be oriented differently with respect to one another than the media objects on the second content page due to the different technical features of the first and second devices.

Various objects, features, aspects and advantages of the inventive subject matter will become more apparent from the following detailed description of preferred embodiments, along with the accompanying drawing figures in which like numerals represent like components.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

FIG. 1 is a schematic of the hardware components of an exemplary system that generates content pages of the present invention.

FIG. 2 is a schematic of the software modules of an exemplary system that generates content pages of the present invention.

FIG. 3 shows the steps involved in an embodiment of an exemplary system that generates content pages of the present invention.

### DETAILED DESCRIPTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. One computer device could be “functionally coupled” to another computer device without a physical connection, for example through a wireless router or through a network connection through a plurality of wired and/or wireless connections.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be noted that any language directed to a computer or a computer system should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

It is noted that the term “computing device” or “client device” is used euphemistically herein to describe any type of computing system that is capable of receiving and serving content page contents to users, such as through a website. Examples of such computing devices include desktop personal computers, laptop computers, tablets, smart phones, PDAs, and smart watches. Generally such client devices have at least one user interface upon which the content page could be instantiated through an application, such as a browser, and have a processor and a tangible, non-transitory computer readable storage medium upon which programming code is saved. The processor then executes the programming code in order to instantiate various modules of the system to generate client code with derived breakpoints. Although the following discussion is directed to the generation and serving of web pages, it is contemplated that the systems and methods described herein could be used for many other types of content pages including, for example, presentations and point of purchase (POP) displays.

One should appreciate that the disclosed techniques provide many advantageous technical effects, including the ability to automatically adapt the configuration templates of section objects on a content page without needing a user to define any breakpoints of the system.

The inventive subject matter provides apparatus, systems, and methods in which a system for generating a client code that instantiates a content page automatically derives a set of breakpoints for different configurations of section objects of the content page, where device attributes above a breakpoint dictate one configuration and device attributes below the breakpoint dictate another configuration.

As used herein, a “content page” is a virtual page of media content that is accessible through a user interface of a computer system or a computer device. Generally, such user interfaces use generic client applications, such as web browsers like Internet Explorer®, Mozilla Firefox® or Google Chrome®, although proprietary client applications could be used without departing from the scope of the current invention. As such, content pages are generally HTML, DHTML, or XHTML based web pages that could have some client-side code that runs locally on the client device, such as JavaScript, ActionScript, Dart, VBScript, Typescript, and typically also use CSS (Cascading Style Sheets) to format the look and feel of the web page. A content page could be logically divided into different blocks containing media object data to help with easily organizing and manipulating data on the content page.

As used herein, a “breakpoint” for a content page is one or more threshold device attributes that client code uses to determine a configuration of section objects on the content page. For example, where the threshold device attribute is a width of a web browser, the client code generates a first configuration of section objects on the content page when the width of the web browser is below the threshold width, and a second configuration of section objects on the content page when the width of the web browser is above the threshold width. Where the threshold device attribute is a toggle switch, the client code generates a first configuration when the toggle switch is turned on, and a second configuration when the toggle switch is turned off. A breakpoint could comprise a plurality of threshold device attributes, such as a configuration that is set when both a width and a height of a web browser exceed both a width threshold and a height threshold, respectively. The one or more breakpoints of a section object can act as triggers upon which media placeholders could be reoriented or resized to display the content within a section object according to one or more device attributes.

As used herein, a “set” of items, such as breakpoints, section objects, or media objects, includes one item to many items. A set of items does not consist of zero items. An empty set will be denoted by the term “null set.”

As used herein, a “section object” is a portion of the content page which has one or more media objects which have been defined in some manner by a user of the system. Such media objects could be defined by a user utilizing a tool of the system to dynamically create content on the fly, such as an image editor, a text editor, a microphone, or an audio/visual recording system. Preferably, the media objects are created by uploading files for non-text media objects, or through a keyboard input or copy/paste system for text media objects.

As used herein, a “media object” includes any sort of media which can be presented on a content page. Content pages are generally displayed on a visual user interface, but could also include audio and tactile user interfaces. Contemplated media objects include text (which includes formatting of the text, such as font, font size, font attributes, alignment, etc.), images, audio clips, video clips, and combinations thereof.

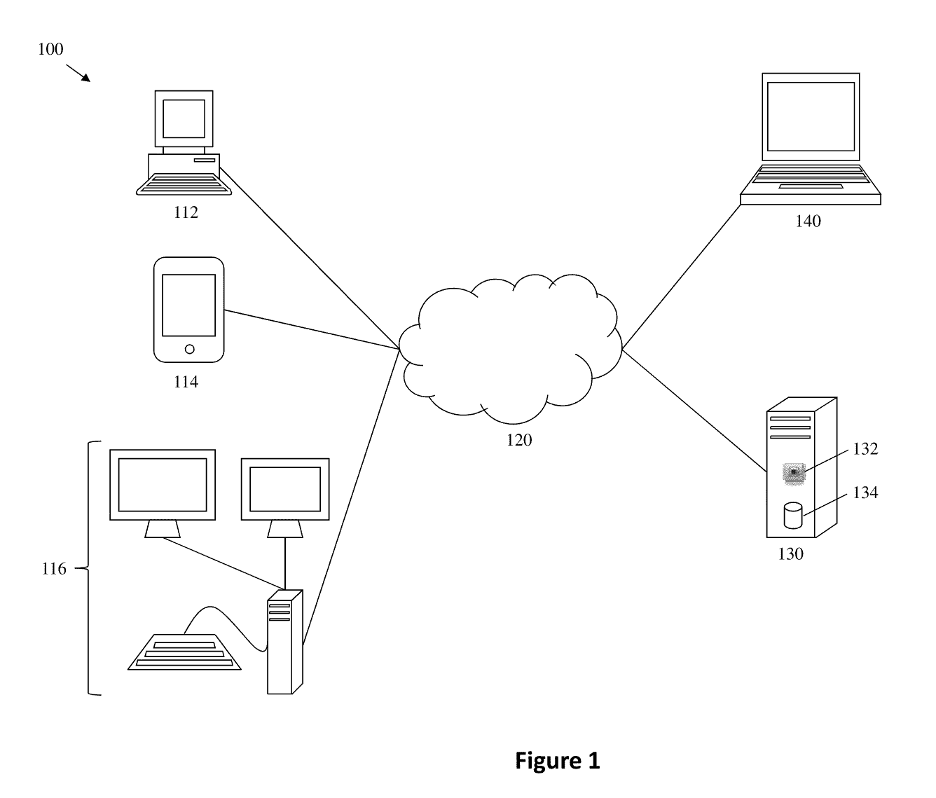

In FIG. 1, an exemplary system 100 has client devices 112, 114, and 116 functionally coupled to a network 120 which is functionally coupled to client code generator 130. Client code generator 130 is administrated through a page generation user interface 140. While client code generator 130 is shown euphemistically as a single computer system having a single processor 132 and a single non-transient memory 134, such a computer system could have a plurality of processors, could have any number of transient and non-transient memories, and could be distributed among several computer system hardware devices functionally connected to one another through a network, such as network 120, without departing from the scope of the current invention. Client code generator 130 executes software computer code (not shown) saved on non-transient memory 134 using processor 132 in order to provide a user at page generation user interface 140 with the ability to build a content page.

While client code generator 130 could have its own user interface directly coupled to a serial port in the computer system, users who wish to build a content page preferably access client code generator 130 through some sort of network 120. Network 120 could be any suitable wired and/or wireless computer network that allows user interface 140 to remotely access client code generator 130 through a functional coupling between the two computer devices, such as an intranet, WAN, LAN, or the Internet. Preferably client code generator 130 provides access to page generation user interface 140 through a web browser on the Internet, so that a variety of users could access client code generator 130 to create their respective content pages using a generic web browser, such as Internet Explorer®, Mozilla Firefox®, Google Chrome® or Opera®. In alternative embodiments, page generation user interface 140 could use a proprietary client interface configured to access client code generator 130 without departing from the scope of the current invention.

Client code generator 130 also has a template database (not shown) saved in non-transient memory 134, which generally holds a number of templates that could be used to create a content page. Each template is saved as a section object having a set of media placeholders and a predefined function that determines where breakpoints should be located once the section object has been populated with media objects. A section object could include some content code that facilitates presentation of the section object on a user device. However, it is also contemplated that the content code could be included in a header of a first page that includes multiple section objects. Whatever the infrastructure, client code generator 130 is configured to allow a user to select one or more of the template section objects to populate a content page through page generation user interface 140. Typically this occurs by presenting a user who logs into client code generator 130 with a list of template section objects. A user could then select one or more template section objects through page generation user interface 140 and place the selected section object(s) in an appropriate location on the content page the user is building.

The media placeholders of the selected section objects are typically blank or filled with template dummy data. A user could then use page generation user interface 140 to define the contents of the media placeholders. In a basic embodiment, a user could define the content of a media placeholder by uploading a file or by utilizing a media creation tool through page generation user interface 140. In other embodiments, a user could define attributes of the media placeholder, such as maximum and minimum dimensions (e.g. height and width), orientations of media objects, and locations of media objects relative to one another.

Client code generator 130 is configured to automatically derive a set of breakpoints (a set of breakpoints containing at least one breakpoint) in accordance with the predefined function coupled with each section object. A section object could have more than one predefined function to define the breakpoints. Once the set of breakpoints are defined, client code generator 130 could generate client code that will define how the content page will be presented to the various client devices 112, 114, and 116. The client code could be hosted on a web server on client code generator 130, or could be hosted on any web server functionally coupled to network 120.

Client devices 112, 114, and 116 are computer devices functionally coupled to network 120, which are configured to access the client code generated by client code generator 130. Client device 112 is shown as a desktop computer system having a large display, such as 1680×1050 pixels, client device 114 is shown as a mobile device having a small display, such as 1136×640, and client device 116 is shown as a computer system having two large displays of differing resolutions, such as 1680×1050 pixels and 1024×768. Each client device could use the entire screen to display the content page, or could use only a portion of the screen in a window to display the content page. When the client code is run on client device 112, the client code generally gleans at least one device attribute, such as the dimensions of a browser window displaying the content page, and configures the presentation of the client code as a function of the device attributes and the set of breakpoints. Typically, the client code compares the device attributes to the set of breakpoints, and determines whether the device attribute is above a breakpoint or below a breakpoint. Where the attribute is above the breakpoint threshold, one configuration is used, and where the attribute is below a breakpoint threshold, another configuration is used. The specific methods used by client code generator 130 and the client code itself are described in further detail when analyzing the modules instantiated by the software on non-transient memory 132.

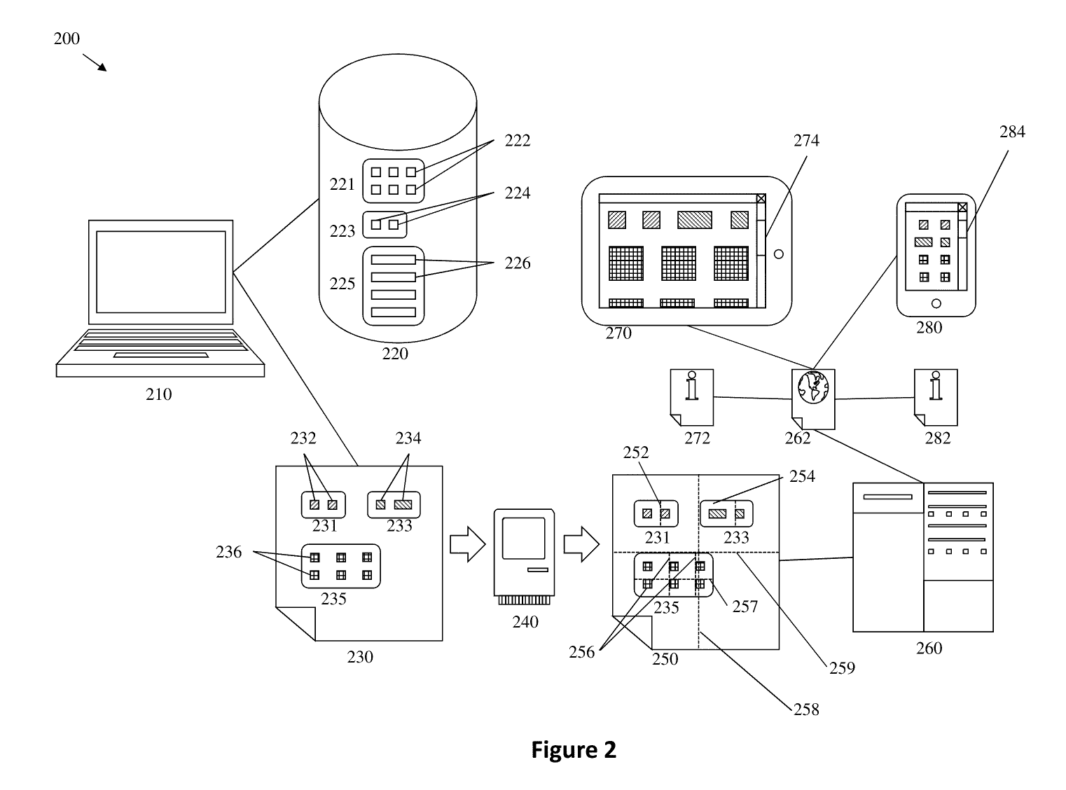

FIG. 2 shows the software modules 200 instantiated by software on non-transient memory 132, software on page generation user interface 140, and on any of the client devices, such as client device 112. The software modules 200 generally include a user interface module 210 that handles communication between the system and a user who wishes to build a content page, a template database module 220 that stores template section objects used to help a user build a content page, a page configuration engine 240 that analyzes the populated template section objects selected and defined by a user to derive a set of breakpoints, and a page server 260 that constructs client code that will build the content page on a client device as a function of the client device's attributes and the derived breakpoints.

User interface module 210 instantiates an interface through which a hardware user interface, such as page generation user interface 140, communicates with the system for generating content pages. Preferably, user interface module 210 has a web page server that allows any user with a client internet browser to connect to the system, although user interface module 210 could also use a proprietary interface that functionally connects to a proprietary client application without departing from the scope of the current invention. A user will generally log into user interface module 210 using a username and password, from which the user could then construct a content page that is linked to an account, usually through a unique identifier (UID) of the user. Once the system receives a command through user interface module 210 to create a new content page, for example by activating an “add new page” button, user interface module allows a user to add one or more section objects to the content page. Generally, the user adds each section block one at a time, for example by activating an “add new block” button which acts as a trigger to instruct user interface module 210 to present a list of template section objects from template database 220.

Template database 220 is a software database module that stores exemplary blank template section objects 221, 223, and 225. As shown, template section object 221 is a section object comprising a set of six media placeholders 222, template section object 223 is a section object comprising a set of two media placeholders 224, and template section object 225 is a section object comprising a set of four media placeholders 226. Template section object 221 could be a media block, template section object 223 could be a text and media block, while template section object 225 could be a media grid block. Section objects 221, 223, and 225 are shown euphemistically as section objects that hold a finite number of media placeholders for simplicity, but could be configured to hold an infinite number of media placeholders (as storage space allows), which could be appended to an end of a list of media placeholders. A layout definition within a template may comprise section objects including, a header, a footer, a main content blocks, any combination of menus and sub-menus, one or more breakpoint functions to derive breakpoints, one or more configuration functions to define different configurations as a function of derived breakpoints, etc. The template could also include content that defines the look and feel (graphical characteristics) of the generated web pages, such as common graphic object, colors, font type/size, and so forth.

In other contemplated embodiments, the content database could be configured to allow storage of a plurality of media objects. Media objects may include one or more text strings, images, audio content, and/or video content. Decoupling the template and content databases provides a great deal of flexibility in creating and customizing a page. For example, when creating a page, a user might predefine the content of the data elements to be served or presented by the page independent from the actual graphical design or look-and-feel of the page. In this manner, the process of creating the page becomes much more efficient and reduces the time required for page maintenance. This provides for an efficient process of website and other content creation and for a highly maintainable collection of web or other content pages.

Once a user has selected and positioned section objects into a virtual content page through user interface module 210, the user could then define content for each section object by inserting media objects into the media placeholders. In the example, user interface module 210 enables a user to create content page 230, having two template section objects 223—shown as section objects 231 and 233—and one template section object 221—shown as section object 235. Through user interface module 210, the user has organized and populated virtual content page 230 by placing section object 231 and 233 side-by-side, and has placed section object 235 below section objects 231 and 233.

At any time after a user has placed a section object into a virtual content page, page configuration engine 240 could derive a set of breakpoints for virtual content page 230, resulting in virtual content page 250. Generally, the breakpoint functions used by page configuration engine 240 are associated with each section object and are stored with the section objects in template database 220. In the example shown in FIG. 2, page configuration engine 240 has derived breakpoint 252 for section object 231, breakpoint 254 for section object 233, vertical breakpoints 256 for section object 235, and horizontal breakpoints 257 for section object 235. Page configuration engine 240 has also derived a breakpoint 258 for content page 250. Vertical breakpoint 252 has been derived as a function of the width of the leftmost media object 232 in section object 231, vertical breakpoint 254 has been derived as a function of the width of the leftmost media object 234 in section 233, the vertical breakpoints 256 have been derived from the width the two left and the two middle media objects 236, and horizontal breakpoint 257 has been derived from the height of the top row of media objects 236. Vertical breakpoint 258 has been derived from the width of section object 231 and horizontal breakpoint 259 has been derived from the height of section objects 231 and 233. The derived breakpoints of virtual content page 250 have been configured such that when a client window displaying a content page has been resized past a breakpoint threshold, the configuration of media objects changes from one configuration to another. In the case of breakpoints 258 and 259, the configuration of section objects changes from one configuration to another. Vertical breakpoints 252, 254, and 256 are used for a virtual content page that is configured to scroll up and down, while horizontal breakpoints 257 and 259 are used for a virtual content page that is configured to scroll left to right.

Page configuration engine 240 is preferably configured to derive new breakpoints whenever a user alters or updates media objects and other content for virtual page 250 to ensure that the breakpoints for virtual content page 250 remain current, although page configuration engine 240 could be configured to derive new breakpoints in response to other triggers, such as when a user clicks a “finished” button through user interface module 210. In either case, once a user has defined the content of virtual content page 250, and page configuration engine 240 has derived the breakpoints for virtual content page 250, page server 260 could then generate client code 262, which instantiates a content page on various client devices.

Client code 262 is preferably a web-based code such as HTML having client-side code, such as JavaScript, ActionScript, Dart, VBScript, and/or Typescript, possibly also having CSS definitions that affect the presentation of the content page on the client device. Client code 262 is generally configured to gather information about a client device to use as a variable in the function to determine how to configure and display media objects on a client device. Client code 262 has been configured to generate content pages that scroll up and down, and thus uses only the derived vertical set of breakpoints.

For example, client code 262 is configured to glean device attributes 272 from client device 270 to create a content page 274. In the example of FIG. 2, client code 262 configures the presentation of the section objects for virtual content page 250 as a function of the width of web browser of client device 270. As shown, since the width of content page 274 lies to the right of each of the derived breakpoints, section objects 231, 233, and 235 are presented in the configuration that the user placed them in virtual content page 250. Client code 262 has also been configured to proportionally stretch the media objects in web browser 274, although client code 262 could have been configured to merely space out the media objects evenly without departing from the scope of the current invention. Each of these settings could have been set by the user via user interface module 210.

In contrast to client device 270, client code 262 gleans device attributes 282 from client device 280 to create content page 284. Since the width of the web browser for client device 280 is smaller than breakpoint 258 and the right-most of vertical breakpoints 256, section objects 231, 233, and 235 are presented in a different configuration. Section object 231 lays above section object 233, and section object 235 now displays its media object in a 3×2 grid instead of in a 2×3 grid.

In this manner, one or more section objects and/or one or more media objects could be presented in different configurations on different computing devices using the same client code, without the need of server-side alterations. For example, on a smart phone, a section object comprising text and an image may be oriented with the text above the image, while on a desktop computer the section object may be oriented with the text to the side of the image.

It should be noted that, while page configuration engine 240 derived horizontal breakpoints 257 and 259, for section object 235, the horizontal breakpoints were never used because client code 262 was configured to construct a content page that scrolls from top to bottom, and was not configured to display a content page that scrolls from the left to the right.

While the exemplary breakpoints in FIG. 2 have been derived as a function of a width of the media objects, and have used the width of the client web browser to determine the display configuration of the content pages, other visual breakpoints and other device attributes could be used. For example, a user might prefer a web page that scrolls from left to right instead of a page that scrolls from top to bottom, and so may use horizontal breakpoints to ensure that the entire web page properly displays in a web browser of a set height. Or a client browser may have a flag that indicates a preference for a web page that scrolls vertically over a web page that scrolls horizontally, which would cause client code 262 to use vertical breakpoints over horizontal breakpoints. In addition, while visual breakpoints have been derived for illustrative purposes, the derived breakpoints could be dependent upon any device attribute that varies from device to device. For example, breakpoints could be derived as a function of a browser type or device types, where different browsers or different types of devices could include different types of media objects (e.g. an Adobe Flash™ file on a desktop computer and an HTML5 file or an image file on an iPhone®). Other breakpoints could be derived as a function of user rights, where a user in group 1 might have a first configuration of media objects, and a user in group 2 might have a second configuration of media objects.

Contemplated section objects include hero blocks, text blocks, media blocks, text and media blocks media grid blocks, media gallery blocks, content slider blocks, tab blocks, table blocks, list blocks, page list blocks, social feed blocks, social link blocks, social share blocks, form blocks, contact information blocks, and custom made blocks. Hero blocks are commonly used as the first section on the top of many web pages. Hero blocks are structured for the communication of powerful statements that are often the main point of a site. They typically use full-width images with text overlaid, sometimes multiple photos and several buttons, guiding users to the most important content on their site. Blank template hero blocks typically allow a user to add a media image which scales to the size of a width or a height of a window, to add text that overlays the media image or lays just above or just below the media image, and one or more buttons that link to other portions of the page or to other pages of the website. A plurality of media images or media videos could span the hero block, and a slider button could be added that allows a client device to slide from one media image/video to another media image/video. Breakpoint functions for hero blocks typically comprise a minimum width and/or a minimum height. When the width of height of the browser window is above the minimum threshold, the media image is scaled to span the entire width or height of the browser window, respectively. When the width or height of the browser window is set below the minimum threshold, the window is set to reset the browser window back to the minimum height or width, to prevent the browser window from shrinking below the minimum, or to fix the size of the media image/video to the minimum size without scaling further. A minimum threshold is typically set as a static number (e.g. a global setting that dictates that the minimum width of any page is 300 pixels) or could be a variable dependent upon the media object (e.g. the minimum width of any image is 70% of the width of the raw image size).

Text block section objects hold blocks of text, referred to as text media objects. This block is typically used for a headline area on a page or a diving section within a page. A text block could have a background image that spans a width or a height of a webpage, and the text itself could be highlighted to be one or more colors. A plurality of text blocks of different highlighted colors or background colors could be introduced, for example a first text block of a first color could be placed above two text blocks placed side-by-side one another of a second and third color. Each text block could be aligned along one or more edges of the background, and one or more text blocks could act as buttons that act as links to other parts of the web page, other pages, or as inputs to a form. Breakpoint functions of text blocks typically comprise a minimum width or a minimum height, similar to the breakpoint functions of hero blocks.

Media blocks are sections of a content page that hold non-text media objects, such as images, audio clips, or video clips—referred to as image media objects, audio media objects, and video media objects, respectively. Media blocks are similar to text blocks, but hold non-text media objects, which could be more dynamic than simple text blocks, since loading a media into a block could comprise loading a streaming audio or video file. Many types of media can be loaded into a placeholder of a media block, such as personal photos, stock photos, videos from YouTube® or audio files from SoundCloud®. This block could also include a title, body text and media description, essentially adding the ability to add text to a media block. Breakpoints functions for media blocks are also similar to hero blocks and text blocks, which have a minimum width or a minimum height set forth to prevent a window from falling below such a minimum, or to prevent a media object from scaling smaller than the minimum.

Text and media blocks are sections of a content page that hold both blocks of data and media objects, such as one or more blocks of text to a side of non-text media file, or just above or below a non-text media file. Since the two sections of a text and media block are next to one another, the parts of the text and media block could be configured in a plurality of ways. The text media object could be placed to the left of the non-text media object, to the right, above, or below. The configuration is usually dependent upon the breakpoint, which is usually determined as a function of a dimension of either the text media object, or the non-text media object. For example a text and media block could be configured to have a text object to the left of a non-text object. A first breakpoint is formed which sets forth a minimum width breakpoint of the non-text media object, and a second breakpoint is formed at the minimum width of the text media object added to the minimum width of the non-text media object. Where the width of the browser is longer than both breakpoints, the text media object is placed to the left of the non-text media object, and the non-text media object is scaled to fit the empty space on the right side of the browser. Where the width of the browser is longer than the minimum width breakpoint of the non-text media object, but shorter than the minimum width of the text media object added to the minimum width of the non-text media object, the text is reconfigured to be above the non-text media object. Where the width of the browser is shorter than the minimum width breakpoint of the non-text media object, the width of the browser is fixed at that minimum width to prevent the browser window from shrinking. Other methods of configuring such a breakpoint could be used without departing from the scope of the current invention.

Media grid blocks are sections of a content page that hold non-text media objects and/or text media objects in a grid pattern. The media grid block allows for a grid-style layout that allows for a media position as well as a title and body text for each item. This is a great selection for instructional content, a list of visual sections such as separate portfolios and visually illustrating the major points on your site. Each element of the grid could comprise one or more media objects. For example, a grid could comprise a plurality of elements, where each element has a title text media object above a description text media object which is above an image media object. In another embodiment, a grid comprises a plurality of elements, where each element has an audio media object above a title text media object above a description text media object. Each element could have a minimum width or a minimum height value associated with it. For example for elements that comprise two text media objects above an image media object, a minimum width could be set as 100% of the size of the widest media object, or a minimum height could be set as the height of the two text media object added to the height of the image media object. In embodiments which are dependent upon a width breakpoint, a maximum number of grid elements per row could be set by a user to ensure that a very wide window does not have an absurd number of grid elements in its first row (e.g. 20 grid elements per row).

Media gallery blocks are sections of a content page that show media objects as a gallery of media to be showcased, usually displayed as one or more lines of thumbnails set forth above or below a larger window that shows a larger image or video, or a list of audio file titles along with a currently playing audio file. As a user clicks one of the thumbnails, the featured media object is then displayed or plays within the larger window. Content breakpoints could be derived as a function of either the main media window or as a function of the thumbnails. For example, a row of thumbnails could be placed above a larger window showcasing a full-sized version of an image media object. As the window shrinks past one or more breakpoint thresholds, the client code could be configured to start removing thumbnails until a minimum number of thumbnails is reached, at which point the window number of thumbnails remains static, even if the user wishes to shrink the window further.

Content slider blocks are sections of a content page that show a small set of media objects, having a slider button that slides from one set of media objects to another set of media objects when the slider button is activated. Content slider blocks work similarly to lists of thumbnails, where a minimum number of sets of media objects could be set, which are dependent upon a height or a width of a browser window.

Custom made blocks are sections of a content page that are custom-made by users who wish to code their own blocks using native tools such as HTML, CSS, and/or JavaScript. Using such custom made blocks, a user could create their own blocks, setting forth default template attributes. For example, a user could set forth the number and types of media objects, how the media objects are configured about a screen, how breakpoints are formed, how the configuration is altered as breakpoint thresholds are changed depending upon settings and attributes of the client device, etc. Once a user creates a custom made block, the user could export such a block to the template section object database for use by that user, or by other users of the system, and the system will automatically derive breakpoints in accordance with the function(s) defined by the user.

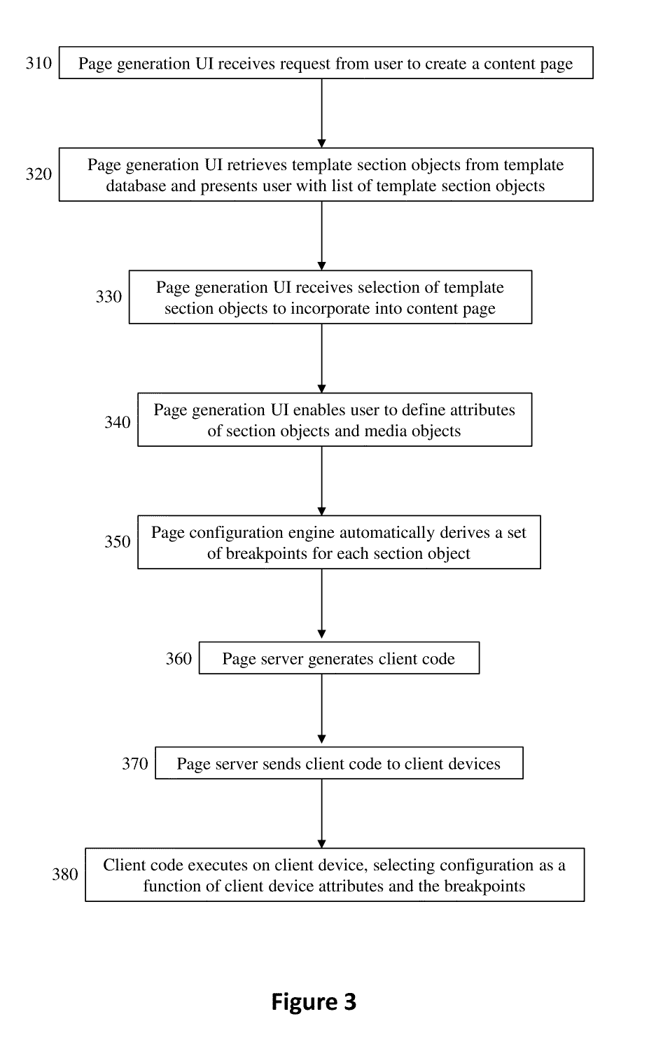

In FIG. 3, a flowchart illustrating the set of steps performed by an exemplary system is shown. In step 310, a page generation user interface receives a request from a page generation user to create a content page. This is generally received as a “create new page” command from a web browser or other client system. In response, in step 320, the page generation user interface retrieves template section objects from a database, and presents the user with a list of template section objects that could be used to populate the content page. In general, this is shown as a list or grid of section objects which the user could select from, along with information regarding the properties of each section object, such as a list of the dimensions of the section object, how the section object might be configured, and how the breakpoints are determined. After the user selects one or more section objects, in step 330, the page generation user interface receives the selection of template section objects to incorporate into the content page, and also generally provides the user with a toolset to place the section objects in various locations about the content page.

In step 340, the page generation user interface enables a user to define attributes of the selected section object and media objects. Generally, the page generation user interface also provides the user with a toolset to define attributes such as a minimum size and maximum size of a media object, whether the media object is to be scaled, how the breakpoints are to be determined, whether certain breakpoints should be added or removed, a hierarchy of configuration functions (e.g. which configuration overrides in a situation where a plurality of configuration functions are applied to a web page, and two or more configuration functions conflict), etc. In step 350, the page configuration engine then automatically derives a set of breakpoints for each section object, and may even derive a set of breakpoints for a set of section objects (such as breakpoint 252 for section objects 231 and 233 in FIG. 2).

In step 360, the page server gleans generates client code which has at least one configuration function that configures the presentation of section objects and/or media objects on a content page as a function of the breakpoints and attributes of the client device. In step 370, the page server sends client code to client devices. Generally, this is done by publishing the client code to a web site that is accessible by client browser devices. Once a client browser device downloads the client code, the client code could then execute on the client device in step 380, gleaning device attributes from the client device (such as browser type, browser size, user settings, user rights, etc.) and could select a configuration of the section objects and/or media objects as a function of one or more client device attributes and one or more of the derived breakpoints.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for generating a content page, comprising:
a template database configured to store a plurality of section objects, each of which comprises a set of media placeholders;
a page generation user interface, wherein the page generation user interface is configured to enable a user to select and define content for a first section object and a second section object from the plurality of section objects;
a page configuration engine configured to derive a set of breakpoints for the content page, wherein the content page comprises the first section object and the second section object; and
a page server configured to generate client code that instantiates a configuration of the first section object and the second section object on the content page as a function of the set of breakpoints and a set of device attributes of a client device.

2. The system of claim 1, wherein the plurality of section objects comprise text blocks that accept a text media object and media blocks that accept at least one of an image media object, an audio media object, and a video media object.

3. The system of claim 1, wherein the plurality of section objects comprise a text and media block that accepts both a text media object and at least one of an image media object, an audio media object, and a video media object.

4. The system of claim 1, wherein the page configuration engine derives at least one of the set of breakpoints as a function of a width of the text media object.

5. The system of claim 1, wherein the plurality of section objects comprise a media grid that accepts a plurality of a type of media object, wherein the type is selected from the group consisting of a photo media object, an audio media object, and a video media object.

6. The system of claim 5, wherein the media grid also accepts a plurality of text media objects.

7. The system of claim 5, wherein the page configuration engine derives a first breakpoint of the set of breakpoints as a function of a width of a first media object.

8. The system of claim 7, wherein the page configuration engine derives a second breakpoint of the set of breakpoints as a function of a width of the first media object and a second media object.

9. The system of claim 1, wherein the plurality of section objects comprise a content slider block that accepts a plurality of media objects, and wherein the configuration of the first section object and the second section object comprises a slider button that slides the first section object in a direction when the slider button is activated.

10. The system of claim 1, wherein the plurality of section objects comprise a table block that accepts a table of media objects.

11. The system of claim 1, wherein the page configuration engine derives a width breakpoint of the set of breakpoints as a function of a width of the first section object.

12. The system of claim 1, wherein the page configuration engine derives a height breakpoint of the set of breakpoints as a function of a height of the first section object.

13. The system of claim 1, wherein the page configuration engine derives a pointer breakpoint of the set of breakpoints as a function of a location of a pointer of the client device.

14. The system of claim 1, wherein the set of device attributes comprises a dimension of a web browser.

15. The system of claim 1, wherein the set of device attributes comprises a browser type.
